(19) United States
(12) Patent Application Publication
(10) Pub. No.: US 2009/0273470 A1
(43) Pub. Date: Nov. 5, 2009

(54) Environmental monitoring and control system

(76) Inventors: Vytas Sinkevicius, Kelowna (CA); Patricia Anne Curran, Kelowna (CA)

Correspondence Address: Vytas Sinkevicius, c/o Bull Housser & Tupper, 3000 Royal Centre, 1055 West Georgia Street, Vancouver, V6E 3R3, CA

(21) Appl. No.: 12/382,734

(22) Filed: Mar. 23, 2009

Related U.S. Application Data
(60) Provisional application No. 61/064,714, filed on Mar. 21, 2008.

(51) Int. Cl. G08B 1/08

(52) U.S. Cl. 340/539.26

(57) ABSTRACT

A wireless environmental monitoring system is disclosed comprising at least one monitor unit in wireless communication with a remote monitoring centre by way of the Internet and a server unit wherein the server unit is in wireless communication with both the monitor unit and the remote monitoring centre. The monitor unit comprises at least one sensor configured to detect an anomalous environmental condition such as the presence of or undesirable change in environmental variables. The monitor unit further comprises an alarm system and a relay output wherein the relay output is configured to trigger an event in response to the anomalous environmental condition to mitigate damage that may be caused by the anomalous environmental condition. The remote monitoring centre is configured to receive and monitor the operational parameters of the monitor unit to interpret an anomalous environmental condition detected by the monitor unit in light of operational variations which may affect the accuracy of the monitor unit. The remote monitoring centre is also configured to receive and communicate environmental data to the monitor unit to establish the base threshold level used to determine an anomalous environmental condition.

### PRIORITY CLAIM

This application claims the benefit to U.S. Provisional Patent Application No. 61/064,714 entitled ENVIRONMENTAL MONITORING AND CONTROL SYSTEM filed on the 21 Mar. 2008, which is hereby incorporated by reference.

### FIELD OF THE INVENTION

The present invention relates generally to an environmental monitoring system, and more particularly, it relates to a wireless monitoring and control system configured to monitor, detect, alert, and react to control undesirable environmental conditions.

### BACKGROUND OF THE INVENTION

Whether it be in a residential, commercial, of industrial setting, the ability to monitor and detect various environmental conditions is crucial to the safety of the people that spend time within such environment. For example, in an industrial plant, the presence of or unacceptably high levels of certain chemicals or gases in the air may be hazardous to health and safety of its employees. In the food industry, the temperature or the presence of bacteria within the processing environment may contaminate the food product and compromise its ability to meet strict safety standards. As another example, in a multi-level residential building of thirty or more apartment units, high levels of toxic gas originating from one unit may have a negative impact on the people living in the surrounding units as well.

Environmental conditions also include factors that affect the comfort and productivity of people in residential, commercial, or industrial settings. For example, temperature and humidity are two examples of environmental conditions that people typically have means to manipulate within the home and the workplace to create a comfortable environment to carry on day to day activities. Air conditioners cool offices on hot summer days so people may comfortably work in their business suits; despite the heat outdoors and humidifiers inject moisture into the air on dry winter days to relieve itchy skin and dry throat.

Monitoring systems for detecting adverse environmental conditions using different sensors systems and techniques are known in the art. U.S. Pat. No. 7,230,528 to Kates describes a wireless sensor system that includes one or more sensor units and a base unit that can communicate with a large number of sensors. When one or more of the sensors detect an anomalous condition (e.g. smoke, fire, water, etc.), the sensor communicates with the base unit and provides data regarding the anomalous condition. The base unit can contact a supervisor or other responsible person by a plurality of techniques, such as, telephone, pager, cellular telephone, Internet, etc. In an embodiment, one or more wireless repeaters are used between the sensor and the base unit to extend the range of the system and to allow the base unit to communicate with a larger number of sensors.

United States Patent Application Publication No. 2006/0273896 to Kates discloses a sensor system that provides an adjustable threshold level for the sensed quantity described. The adjustable threshold allows the sensors to adjust to ambient conditions, aging of components, and other operational variations while still providing a relatively sensitive detection capability for hazardous conditions. The adjustable threshold sensor can operate for extended periods without maintenance or recalibration. When one or more of the sensors detect an anomalous condition (e.g. smoke, fire, water, etc.), the sensor communicates with the base unit and provides data regarding the anomalous condition. The base unit can contact a supervisor or other responsible person by a plurality of techniques, such as, telephone, pager, cellular telephone, Internet, (and/or local area network), etc. In an embodiment of the invention, one or more wireless repeaters are used between the sensor and the base unit to extend the range of the system and to allow the base unit to communicate with a larger number of sensors.

U.S. Pat. No. 7,302,313 to Sharp et al. describes an air monitoring system having an air monitoring unit with at least one sensor for measuring data of an air quality parameter and a computer for storing the air quality parameter: data received from the sensor. The air monitoring unit may use an installed or a portable system of a combination of both, for measuring the air quality parameters of interest. A remote data centre may be provided, and the data may be uploaded to the data centre from the unit by a communications media such as the Internet. Information or instructions may also be downloaded from the data centre to the unit via the communications media for controlling or modifying; the function of the unit. An expert system may be provided with the air monitoring system for controlling the unit so as to customize, the unit through use of the Internet. The information or instructions downloaded to the unit may be generated by the expert system.

PCT patent application International Publication Number WO/0235494 to Hellström et al. describes a system for monitoring one or more environments and a method and computer software means for carrying out same. A measurement of a parameter in an environment is made by a sensor means. A signal containing information from the sensor means is communicated via a communication device and a communication network to a remote reference database for evaluation by comparison. On comparison with information stored remotely the parameter measurement value is identified and quantified.

While the prior art systems provide for a number of different environmental monitoring abilities, such systems have inherent inaccuracies because they fail to account for the natural fluctuations of ambient environmental conditions and for ordinary imprecision of the system due to continuous operation. Without the ability to compare the environmental condition with a true and up-to-date standard, any such prior art environmental monitoring systems will never be truly accurate and reliable. Furthermore, the prior art systems fail to provide for a means to trigger a response when an anomalous environmental condition is detected so as to mitigate or control the condition. Without the ability to immediately respond to an anomalous environmental condition, irreparable damage may already be caused before assistance arrives to address the situation. In addition, the prior art systems fail to provide a simple and easy to use, maintain, and install system for larger commercial and/or residential applications. Prior art systems require a plurality of sensors and repeater units which translate into more parts to maintain and a greater chance for error, for example, if one part malfunctions, thereby compromising the integrity of the entire system. Accordingly, there is a need in the art for a wireless environmental monitoring system that overcomes the foregoing problems.

### SUMMARY

It is an object of the invention to provide a wireless environmental monitoring system that utilizes internet connectivity to continuously monitor, detect and alert users of an anomalous environmental condition.

It is a further object of the invention to provide a wireless environmental monitoring system that utilizes internet connectivity to continuously monitor the operational parameters of the system and the regional ambient temperature.

It is a further object of the invention to provide a wireless environmental monitoring system that is capable of triggering a response when an anomalous environmental condition is detected.

It is a further object of the invention to provide a monitoring and maintenance service that is in communication with the wireless environmental monitoring system by way of the Internet to provide end users with a reliable and round the clock environmental monitoring service.

In accordance with the present invention, a wireless environmental monitoring system is disclosed comprising at least one monitor unit in wireless communication with a remote monitoring centre by way of the Internet and a server unit wherein the server unit is in wireless communication with both the monitor unit and the remote monitoring centre.

The monitor unit comprises at least one sensor configured to detect an anomalous environmental condition such as the presence of or an undesirable change in environmental variables. The monitor unit further comprises an alarm system and a relay output wherein the relay output is configured to trigger an event in response to the anomalous environmental, condition to mitigate damage that may be caused by the anomalous environmental condition.

The server unit is comprised of a microprocessor configured to facilitate the wireless communication between the monitor unit and the remote monitoring centre.

Remote monitoring centre comprises at least one processor located remotely from the monitor unit. The processor is configured to receive and monitor the operational parameters of the monitor unit and to receive environmental data from regional government agencies via the Internet. The remote monitoring centre communicates the environmental data to the monitor unit to establish the base threshold level used to determine an anomalous environmental condition. The operational parameters of the monitor unit enable the remote monitoring centre to interpret an anomalous environmental condition detected by the monitor unit in light of operational variations which may affect the accuracy of the monitor unit.

### BRIEF DESCRIPTION OF THE DRAWINGS

These and other objects, benefits, or advantages of the invention are described in more detail and will be apparent after reviewing the drawings and description thereof wherein:

FIG. 1 is a flow chart depicting the various components of the wireless environmental monitoring and control system, as described in the present invention;

FIG. 2 is a flow chart depicting the various components of the wireless environmental monitoring and control system as seen in FIG. 1 as applied to a residential setting;

FIG. 3 is a flow chart, depicting the various components of the wireless environmental monitoring and control system as seen in FIG. 1 as applied to a commercial setting;

FIG. 4 is a flow chart, depicting the various components of the wireless environmental monitoring and control system as seen in FIG. 1 as applied to an industrial setting; and

FIG. 5 is a block diagram depicting the function of a monitor unit of the wireless environmental monitoring and control system.

### DETAILED DESCRIPTION OF THE INVENTION

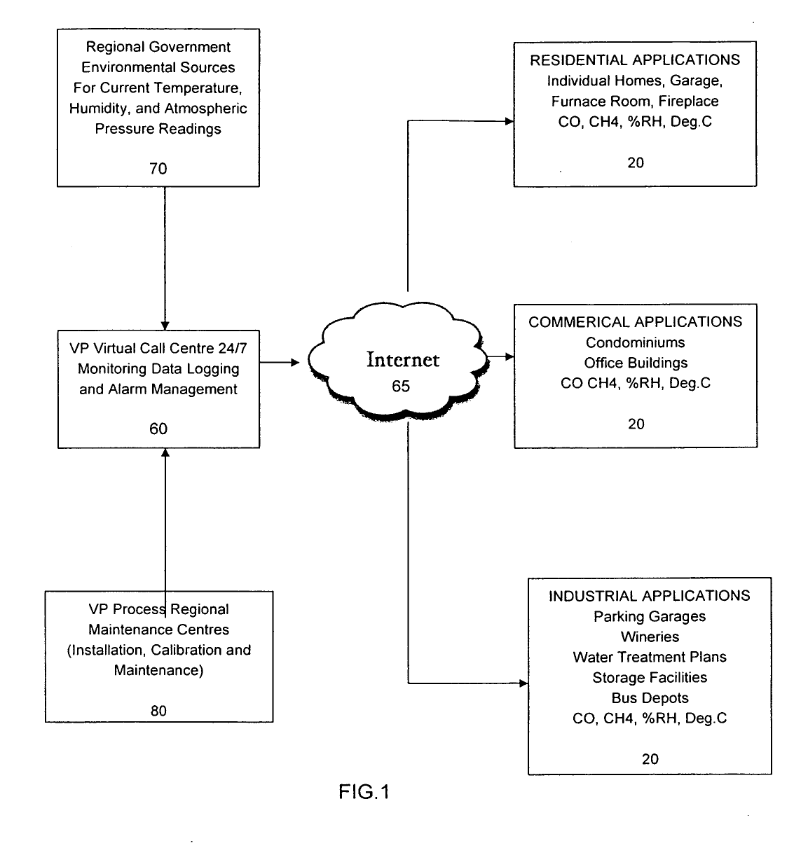

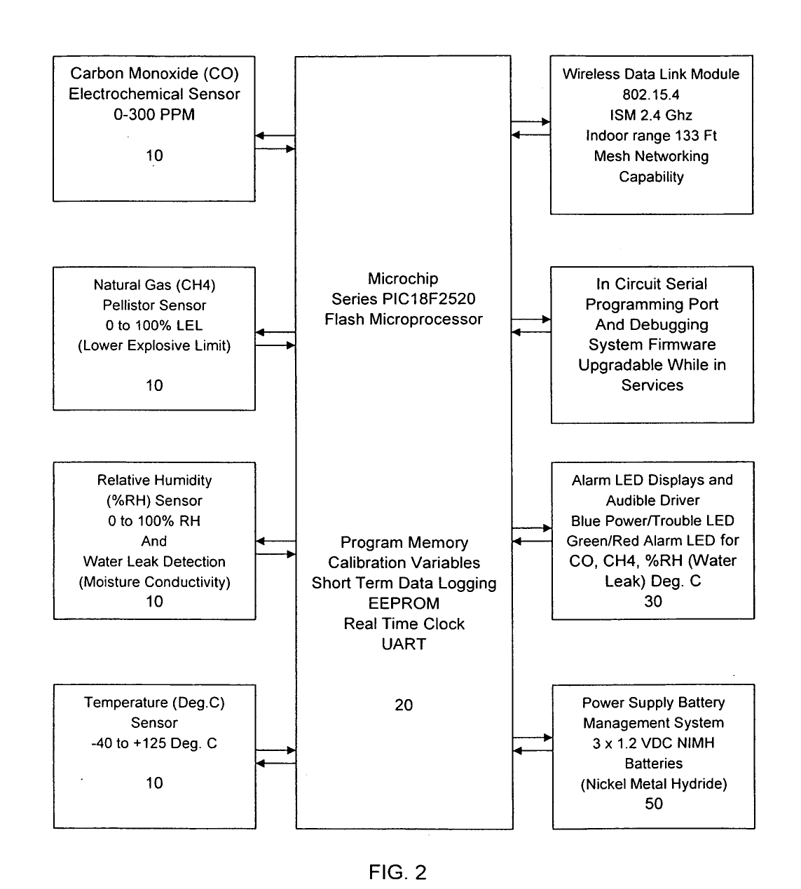

With reference to FIGS. 1 to 5, in accordance with an embodiment of the present invention, there is provided an environmental monitoring and control system 1 comprising at least one monitor unit 20 in wireless communication with a remote monitoring centre 60 by way of a server unit 40 wherein server unit 40 is in wireless communication with both monitor unit 20 and remote monitoring centre 60. Environmental monitoring and control system 1 may be a portable system that may be brought to virtually any physical location to sample the air of such location. Preferably, environmental monitoring and control system 1 is an installable system that may be installed at virtually any location such as but not limited to any residential, commercial, or industrial building, as described in greater detail below.

Monitor unit 20 comprises at least one sensor 10 configured to detect the presence of or undesirable change in environmental variables such as but not limited to carbon monoxide gas, natural gas, and other flammable or toxic gases, relative humidity, temperature, atmospheric pressure, water leak, bacteria, and particulates such as dust, asbestos fibers, pollen, and other airborne irritants and toxins to the human system. Preferably, monitor unit 20 comprises a combination of different sensors. For example, and without intending to be limiting, monitor unit 20 for installation by a fireplace may be configured with temperature and natural gas sensors to detect possible gas leaks or fire whereas monitor unit 20 for installation in a furnace room maybe configured with water, humidity, and natural gas sensors to detect water and gas leakage. In an embodiment of the invention, monitor unit is configured to detect at least four environmental variables.

Sensor 10 may be virtually any type of sensors configured to detect virtually any environmental condition, such as but hot limited to electrochemical sensors, catalytic sensors, infrared sensors, thermometers, pellistors or capacitive sensors. By way of example and without intending to be limiting, the following table sets out the different types of sensors and a sample range of sensitivities of each sensors that may be incorporated in any combination into monitor 20:

| Environmental Variable | Range |
|---|---|
| Oxygen | 0-25% VOL |
| Carbon Monoxide | 0-1000 PPM |
| Hydrogen Sulfide | 0-100 PPM |
| Nitrogen Oxide | 0-20 PPM |
| Ammonia | 0-100 PPM |
| Sulfur Dioxide | 0-2000 PPM |
| Nitric Oxide | 0-1000 PPM |
| Chlorine | 0-20 PPM |
| Hydrogen | 0-10000 PPM |
| Hydrogen Cyanide | 0-100 PPM |
| Hydrogen Chloride | 0-100 PPM |
| Hydrocarbons | 0-100% LEL |
| Carbon Dioxide | 0-10000 PPM |

In the present application, VOL stands for volume; PPM stands for parts per million; and LEL stands for lower explosive limit.

Monitor unit 20 further comprises a relay output configured to trigger an event in response to sensor 10 when an anomalous environmental condition such as the presence of or an undesirable change in environmental variables is detected. For example and without intending to be limiting, in a residential application wherein environmental monitoring and control system 1 is installed in a garage, when sensor 10 of monitor unit 20 detects a dangerous level of carbon monoxide gas, sensor 10 may send a signal to the relay output to cause the garage door to open so as to: ventilate the garage and exhaust the toxic gas. As a further example and without intending to be limiting, in a commercial application wherein environmental monitoring and control system 1 is installed in the furnace room of a commercial building where hot water tanks are typically installed, when sensor 10 of monitor unit 20 detects the presence of water or an increase in relative humidity, which could possibly indicate a water leak, sensor 10 may send a signal to the relay output to cause the water main to be automatically turned off to prevent any further water damage.

In addition to responding to and taking positive action to mitigate an anomalous environmental condition, monitor 20 further comprises an alarm system 30 configured to produce an audible and/of a visual alarm when the presence of or an undesirable change in environmental variables is detected to alert users of the potentially hazardous environment. In an embodiment of the invention, alarm system comprises different audible and/or visual indicators such that the end user may be informed by the type of indicator what specific environmental condition is being detected. For example, and without intending to be limiting, two different coloured LED lights indicators are used to indicate normal conditions and anomalous conditions. For greater clarity, if monitor 20 detects normal levels of carbon monoxide, a green indicator light will flash once per minute but if an anomalous environmental condition is detected, a red indicator light will flash once every two seconds. In another embodiment of the invention, alarm system 30 may be configured to produce an audible and/or a visual alarm reflective of the seriousness of the anomalous environmental condition. For example, and without intending to be limiting, if an anomalous environmental condition is detected, a red indicator light will flash once every two seconds. If monitor unit 20 continues to detect the anomalous environmental condition for a predetermined period of time without improvement, the red indicator light will remain constant and the audible alarm will sound every two seconds. If monitor unit 20 determines that the anomalous environmental condition is at dangerously unsafe levels, the red indicator light will remain lit and the audible alarm will change to a predetermined sound to indicate extreme danger and the audible alarm will sound continuously.

Preferably, monitor 20 further comprises a battery backup system 50 such that monitor 20 may continue to operate without external power in the event power is not available. In an embodiment of the system, the battery backup system includes nickel metal hydride (NiMH) batteries that are kept charged by an available power source.

Server unit 40 is comprised of a microprocessor configured to operate as an intermediary and to facilitate the wireless communication between monitor unit 20 and remote monitoring centre 60. Monitor unit 20, server unit 40, and remote monitoring centre 60 may use virtually any wireless technology to communicate with each other such as but not limited to spread-spectrum and quadrature amplitude modulation but preferably, monitor unit 20, server unit 40, and remote monitoring centre 60 communicate by way of ISM wireless technology. Preferably, only one server unit 40 is required at virtually any location environmental monitoring and control system 1 is installed. In an embodiment of the invention, server unit 40 may operate effectively as an intermediary and facilitate wireless communication between remote monitoring centre 60 and at least two hundred and fifty monitor units 20.

Remote monitoring centre 60 comprises at least one processor located remotely from monitor unit 20 wherein the processor is configured to monitor the operational parameters of monitor unit 20. Operational parameters include but are not limited to aging of components and other operational variations that affect the sensitivity and detection capability of sensor 10 of monitor unit 20. By monitoring monitor unit 20, remote monitoring centre 60 is capable of interpreting an anomalous environmental condition detected by monitor unit 20 in light of the operational parameters which may affect the accuracy of the detection so as to determine whether the alarm system should be activated and/or if the relay output should trigger an event in response.

The processor is also configured to regularly receive environmental data from regional government agencies 70 via the Internet 65 to establish the threshold level to which monitor unit 20 compares the environmental variables of its location to determine if there is an anomalous environmental condition. The environmental data, which includes but is hot limited to temperature, humidity, atmospheric pressure, and level of particulates, may be wirelessly communicated to monitor unit 20 via Internet 65 and server unit 40 such that sensor 10 of monitor unit 20 may continuously operate and monitor environmental variables of the location with reference to the environmental data.

When an anomalous environmental condition is detected, in addition to wirelessly communicating with monitor unit 20 to activate alarm system 30 and/or trigger an event in response, the processor is further configured to contact predetermined key people related to the location of monitor unit 20 to inform them of the detected anomalous environmental condition.

In an embodiment of the invention, the processor is further capable of logging data on the environmental conditions of the location on a predetermined time frequency.

In another embodiment of the invention, environmental monitoring and control system 1 further comprises a maintenance centre 80 that provides maintenance, installation, calibration, replacement, and upgrade services to monitor 20.

### Operation

As will be described in greater detail, when environmental monitoring and control system 1 is installed at a location, monitor unit 20, server unit 40 and remote monitoring centre 60 operates as a cohesive and synergistic system to provide protection against harm and damage caused by the presence of or an undesirable change in environmental variables. When remote monitoring centre 60 receives environmental data provided by local government sources 70, such data is wirelessly communicated to monitor unit 20 by way of Internet 65 and server unit 40. Monitor unit 20 may then operate and monitor environmental variables of the location with reference to the environmental data provided by remote monitoring centre 60, which advantageously increases the accuracy of environmental monitoring and control system 1. For example, a notable increase in humidity, which could indicate a possible water leak, may actually be within normal range having regard to the ambient humidity level for the particular area and for a particular day.

When sensor 10 of monitor unit 20 detects the presence of or an undesirable change in environmental variables, having regard to the environmental data sent through server unit 40 by remote monitoring centre 60, such detection may be sent to remote monitoring centre 60 for further interpretation to determine if alarm system 30 should be activated or if the relay output should trigger an event in response to the detection. To make such determination, operational parameters of monitor unit 20 that may affect the sensitivity and detection capability of sensor 10 of monitor unit 20 are continuously communicated to remote monitoring centre 60 from monitor unit 20 by way of Internet 65 and server unit 40. Remote monitoring centre 60 may then accurately interpret and evaluate the detection in light of the operational parameters to determine if alarm system 30 and/or the relay output needs to be triggered and/or if someone needs to be contacted to provide further assistance at the location of monitor unit 20 to manage the anomalous environmental condition. Alternatively, if the anomalous environmental condition does not warrant alarm, triggering of a response, or contacting someone, remote monitoring centre 60 may simply log the detection data for future purposes, such as for example, to determine if there is a cause for such minor but detectable fluctuations in the environment. Advantageously, the ability of remote monitoring centre 60 to constantly monitor the efficacy of monitor unit 20 ensures optimal function of environmental monitoring and control system 1 by reducing the potential of false alarms due to, for example, faulty or worn components and by providing current operational parameters to inform maintenance centre 80 of the need for maintenance or repair.

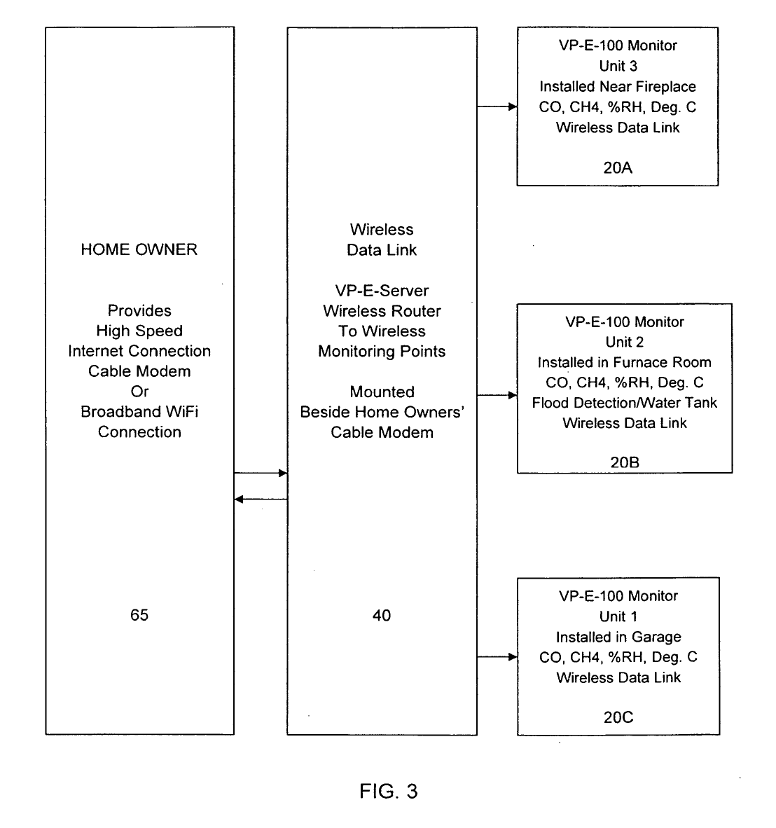

As seen in FIG. 3, in an embodiment of the invention wherein environmental monitoring and control system 1 is installed in a residential location, a plurality of monitor units 20 may be installed throughout the home to detect the presence of or an undesirable change in environmental variables. Server unit 40 may be connected to Internet 65 to provide continuous monitoring and data logging via remote monitoring centre 60. For example, and without intending to be limiting, monitor unit 20 may be installed in the garage, the furnace room and by the fireplace to detect carbon monoxide gas and natural gas leaks. In an embodiment of the invention and as a further example, if a natural gas leak is detected by monitor unit 20A installed by the fireplace, alarm system 30 of monitor unit 20A may be activated and/or the relay output may trigger a fan to be turned on to exhaust the unwanted gas. In an alternative embodiment of the invention and carrying on with the example of monitor 20A detecting an anomalous environmental condition, alarm system 30 for the monitor unit 20B installed in the furnace room and for the monitor unit 20C installed in the garage may also be activated in a manner to indicate an anomalous environmental condition detected by monitor unit 20A by the fireplace. Advantageously, if the user is working in the garage when monitor unit 20A detects an anomalous environmental condition, alarm system 30 of monitor unit 20C installed in the garage may be used to alert the user of the anomalous environmental condition so that the user may immediately investigate and address the condition before it worsens.

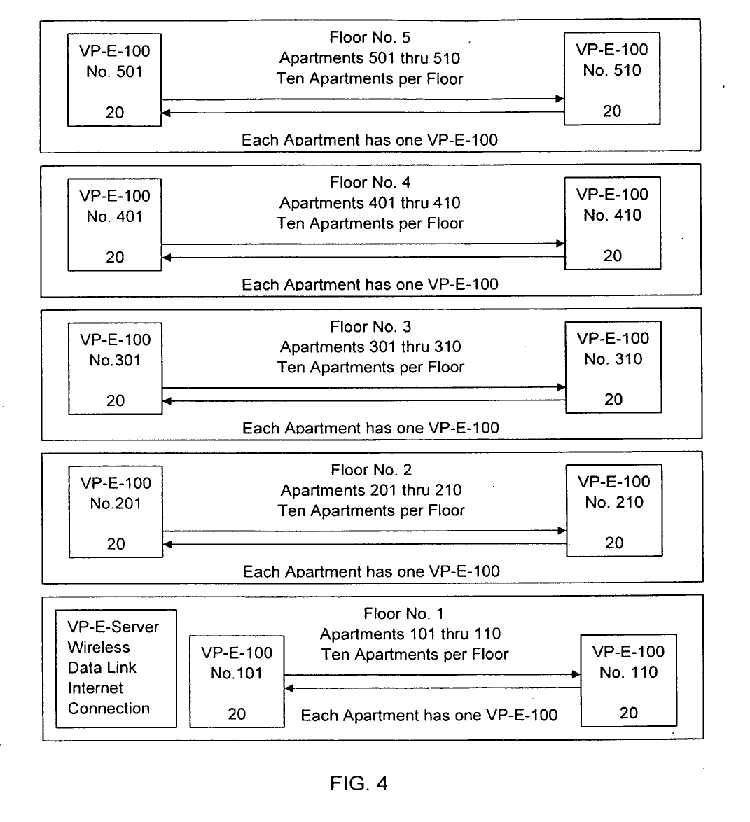

As seen in FIG. 4, in an embodiment of the invention wherein environmental monitoring and control system 1 is installed in a commercial location such as a multi-story condominium building having a number of apartment units per floor, a plurality of monitor units 20 may be installed throughout the building, such as in each apartment unit and in the hallways between the units. In the commercial application embodiment of the invention, typically, only one monitor unit 20 is required per apartment unit to monitor virtually all the environmental conditions of concern or such a location. In an embodiment of the invention, if monitor 20 in one of the apartment units on the fourth floor detects an anomalous environmental condition, alarm system 30 and/or the relay output of monitor 20 in surrounding apartment units may also be triggered to warn surrounding neighbors of the potential danger. A predetermined security protocol may be incorporated or programmed into environmental monitoring and control system 1 used in a commercial application to ensure the safety of its occupants. For example, and without intending to be limiting, if a water leak of excessive humidity level is detected in an apartment unit on the third floor, the predetermined security protocol may require that only alarm system 30 of monitor unit 20 in the apartment units below the third floor need to be activated since water leak damage typically only affect the units below whereas if a temperature increase is detected, indicating a possible fire, the predetermined security protocol would require that alarm system 30 of monitor unit 20 in apartment units above and below should be activated.

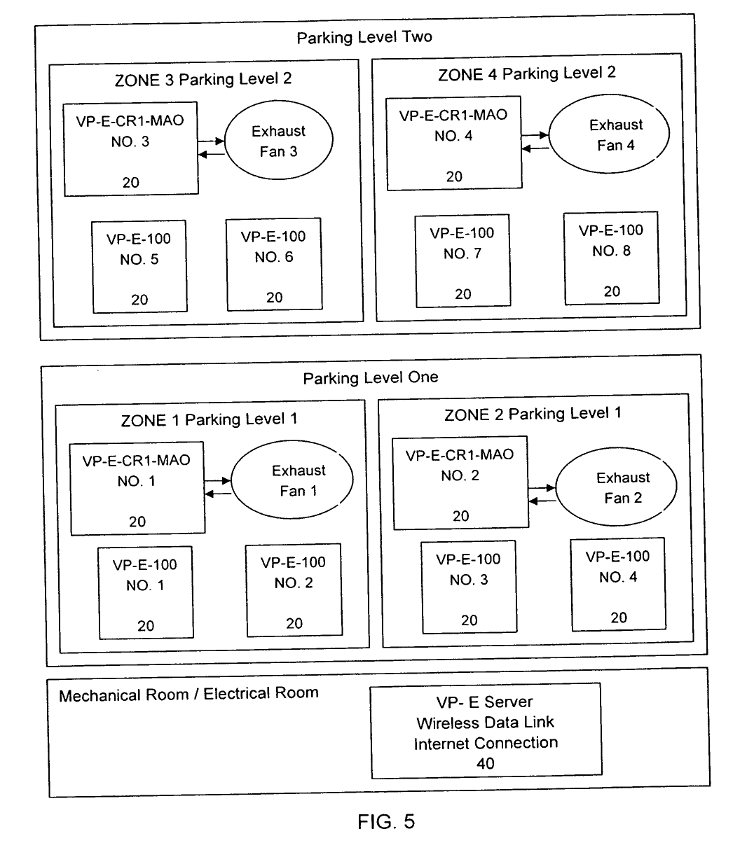

As seen in FIG. 5, in an embodiment of the invention wherein environmental monitoring and control system 1 is installed in an industrial location such as a multi-level underground parking garage, a plurality of monitor units 20 may be installed throughout the levels of the garage to monitor carbon monoxide gas levels and to control the ventilation fan. Typically, as required by local building codes, ventilation fans in underground parking garages need to be running continuously for safety reasons. Advantageously and in an embodiment of the invention, the relay output of monitor 20 may activate the ventilation fan when an elevated carbon monoxide gas level is detected and deactivate the ventilation fan when the carbon monoxide gas level is within normal range, thereby saving energy by not having to run the ventilation fan continuously.

In an embodiment of the invention, environmental monitoring and control system 1 may include the key features set out in the table below.

| Sensor 1 | Carbon Monoxide Gas | Range: 0 to 300 PPM |
|---|---|---|
| | Sensor type: electrochemical | Accuracy: +/−1 PPM |
| Sensor 2 | Natural Gas/Methane Gas | Range: 0 to 100% LEL |
| | Sensor type: Pellistor | Accuracy; +/−1% |
| Sensor 3 | Relative Humidity | Range: 0 to 100% LEL |
| | Sensor type: Capacitive | Accuracy: +/−5% |
| Sensor 4 | Temperature | Range: −40° C. to 125° C. |
| | Sensor type: solid state thermistor | Accuracy: +/−2° C. |
| Sensor 5 | Water Leak Detection | Probe: two wire leads |
| | Excitation voltage: 3.3 volts DC | Input impedance min: 200K |
| Power | 9 volts DC wall plug adapter | |
| Battery | 3.6 volts DC NiMH rechargeable battery system, 2000 mA HR | |
| | rated; on board smart battery charger management system | |
| Wireless Data | 802.15.4 ISM 2.4 GHz | Range: up to 133 feet |
| | Mesh networking capability | indoors; built in wire whip |
| | | antenna |
| | I | |
| Audible Alarm | Internal audible buzzer | 90 decibels at 10 cm for |
| | | critical alarms |
| Push button | Audible silence/test switch | |

| | |
|---|---|
| Power LED | Blue power LED; blinks once per minute for normal operation and |
| | once every two seconds if anomalous environmental condition |
| | detected |
| Sensor Alarm LED | Four sensor LEDs, one each for carbon monoxide, natural gas, |
| | relative humidity, and temperature; each LED blinks green once per |
| | minute for normal, blinks red once every two seconds for first |
| | alarm, and solid red for second alarm for critical condition |
| Water Leak | % relative humidity LED alternates between solid green and sold |
| | red twice per second |
| Alarm Times | Monitor unit 20 has real time clock capability to time stamp and |
| | data log alarms, cleared by remote monitoring centre 60 |
| Power Failure | During power outage, monitor system 20 will stay fully operational |
| | for up to eight hours and data log conditions once every ten minutes |
| | if not able to communicate with server unit 40 |
| Server Unit | Server unit 40 is a standalone processing unit and is not part of |
| | monitor unit 20. If communication is lost with remote monitoring |
| | centre 6- via the Internet, server unit 40 will data log all conditions |
| | to its hard drive. If power is interrupted, server unit 40 will |
| | communicate with monitor unit 20 and download the logged data |
| | and transmit to remote monitoring centre 60 once communication |
| | can be established. |

The foregoing description is made for purpose of illustration only and is not intended to limit the scope of the invention. From the foregoing, it should be clear that the present invention may be embodied in other forms other than those disclosed above without departing from the spirit or essential characteristics of the invention. The above described embodiments are therefore to be considered in all respects illustrative and not restrictive.

I claim:

1. An environmental monitoring system comprising:
(a) at least one monitor unit in wireless communication with a remote monitoring centre; and
(b) a server unit
wherein said server unit is in wireless communication with both said at least one monitor unit and said remote monitoring centre.

2. The environmental monitoring system of claim 1 wherein said at least one monitor unit comprises at least one sensor configured to detect an anomalous environmental condition.

3. The environmental monitoring system of claim 2 wherein said at least one monitor unit further comprises an alarm system and a relay output wherein said relay output is configured to trigger an event in response to said anomalous environmental condition

4. The environmental monitoring system of claim 3 wherein said server unit is comprised of a microprocessor configured to facilitate wireless communication between said at least one monitor unit and said remote monitoring centre.

5. The environmental monitoring system of claim 4 wherein said remote monitoring centre comprises at least one processor located remotely from said at least one monitor unit, said processor configured to receive and monitor operational parameters of said at least one monitor unit and to receive environmental data.

6. The environmental monitoring system of claim 5 wherein said remote monitoring centre communicates environmental data to said at least one monitor unit to establish a base threshold level to determine said anomalous environmental condition.
